(19) United States
(12) Patent Application Publication
(10) Pub. No.: US 2023/0191651 A1
(43) Pub. Date: Jun. 22, 2023

(54) METHODS OF FORMING A STRUCTURE, AND RELATED TOOLS FOR ADDITIVELY MANUFACTURING THE STRUCTURE

(71) Applicant: Northrop Grumman Systems Corporation, Falls Church, VA (US)

(72) Inventors: Benjamin W. Garcia, Tremonton, UT (US); Eric G. Barnes, Rancho Palos Verdes, CA (US)

(21) Appl. No.: 17/553,581

(22) Filed: Dec. 16, 2021

(51) Int. Cl. B28B 1/00; B33Y 10/00; B33Y 40/20; B33Y 30/00; B29C 64/118; B29C 64/30; B28B 11/04; B28B 11/24

(52) U.S. Cl. CPC B28B 1/001; B28B 11/04; B28B 11/243; B29C 64/30; B29C 64/118; B33Y 10/00; B33Y 30/00; B33Y 40/20; B29K 2101/10

(57) ABSTRACT

A method of forming a structure comprising a continuous fiber material comprises continuously feeding, through a continuous fiber nozzle assembly of an additive manufacturing tool, a feed material comprising a continuous fiber material and a thermoset resin material, heating or cooling the feed material to maintain a temperature of the feed material to a temperature sufficient to tackify the feed material and at least partially cure the feed material and initiate adhesion of the feed material on a build platform or a previously formed portion of a structure, and moving the continuous fiber nozzle assembly in three dimensions while depositing the feed material on the build platform or the previously formed portion of the structure to form the structure comprising the continuous fiber material extending in three dimensions. Related methods of forming a composite structure, and related tools for additively manufacturing a structure are disclosed.

### TECHNICAL FIELD

Embodiments of the disclosure relate generally to a method of additively manufacturing a structure, and to related structures. More particularly, embodiments of the disclosure relate to a method of additively manufacturing a structure using a six-axis additive manufacturing tool and a feed material comprising a continuous fiber material in a thermoset resin material, and to related structures.

### BACKGROUND

Fiber composite materials include reinforcing fibers embedded in a matrix material. One example of a fiber composite material is a carbon fiber composite (CFC), which includes reinforcing carbon fibers embedded in the matrix material. CFCs may exhibit a variety of desired properties, such as high temperature stability, high thermal resistance, high mechanical integrity, light weight, corrosion resistance, and desired electrical and magnetic properties. CFCs may exhibit a greater strength at a lower overall weight than metal materials. CFCs can thus be used to form a number of industrial and military structures including, for example, aerospace, marine, and automotive structures requiring one or more of the aforementioned properties.

Fiber composite materials may be fabricated by hand lay-up, automated fiber placement, and tape placement. However, such methods can be labor intensive, expensive, and require expensive tooling and operation especially for low volume production and fabrication of prototypes and test structures.

Other methods of forming fiber composite materials include conventional additive manufacturing techniques (also referred to as 3D printing techniques), such as fused filament fabrication (FFF) (also known as fused deposition modeling (FDM)). While such methods are conventionally referred to as “3D printing”, the methods are actually 2.5D printing, where the additive manufacturing tool builds a structure layer by layer in the XY plane. For example, during conventional additive manufacturing processes, a material layer is built in the XY plane, the build platform of the additive manufacturing tool is moved in the Z-direction, and an additional material layer of the structure is formed in the XY plane over the previously built layer. Thus, additional layers of the structure are formed on previously formed layers to form a three-dimensional structure. Structures formed by stacking sequential 2D layers one over the other may suffer from a lack of uniformity in material properties, such as strength and strain properties, particularly in the Z-direction (the direction perpendicular to the XY plane in which the individual layers are formed).

Various materials may be used for conventional additive manufacturing processes, such as FFF. For example, materials used for FFF include high performance amorphous or semi-crystalline thermoplastic materials including polyetheretherketone (PEEK), polyetherketoneketone (PEKK), polyphenylsulfone (PPSF, PPSU), and polyphenylene (PPS). Additional materials may include acrylonitrile butadiene styrene (ABS), polyacetic acid (PLA), polylactic acid (PLA), polycarbonate (PC), polyamide (PA), polystyrene (PS), lignin, rubber, polyphenylsulfone, ultra-high molecular weight polyethylene (UHMEPE), high impact polystyrene (HIPS), high density polyethylene (HDPE) eutectic materials, and room temperature vulcanization (RTV) silicon. The thermoplastic materials may include one or more additives, such as chopped carbon fibers, chopped glass fibers, chopped quartz fibers, or chopped Kevlar fibers.

### BRIEF SUMMARY

Embodiments disclosed herein include a method of forming a structure comprising a continuous fiber material. The method comprises continuously feeding, through a continuous fiber nozzle assembly of an additive manufacturing tool, a feed material comprising a continuous fiber material and a thermoset resin material, heating or cooling the feed material to maintain a temperature of the feed material to a temperature sufficient to tackify the feed material and at least partially cure the feed material and initiate adhesion of the feed material on a build platform or a previously formed portion of a structure, and moving the continuous fiber nozzle assembly in three dimensions while depositing the feed material on the build platform or the previously formed portion of the structure to form the structure comprising the continuous fiber material extending in three dimensions.

In additional embodiments, a method of forming a composite structure comprises forming a structure using a six-axis additive manufacturing tool. Forming the structure comprises feeding a feed material comprising a pre-impregnated continuous fiber material dispersed within a thermoset resin material through a continuous fiber nozzle assembly of the additive manufacturing tool to a surface of a structure, and while feeding the feed material through the continuous fiber nozzle assembly, exposing the feed material to thermal radiation to at least partially cure the feed material. The method further comprises curing the structure to form a cured structure, and carbonizing the cured structure to form a char structure.

In yet additional embodiments, a tool for additively manufacturing a structure comprises a build platform configured to hold a structure being formed, an end effector including a continuous fiber nozzle assembly, the end effector configured to move in three dimensions with respect to the build platform and configured to rotate along three independent axis, and a feed material comprising a continuous fiber material dispersed within a thermoset resin material.

### BRIEF DESCRIPTION OF THE DRAWINGS

FIG. 1 is a simplified partial perspective view of an additive manufacturing tool, in accordance with embodiments of the disclosure;

FIG. 2 is a simplified partial perspective view of an end effector of the additive manufacturing tool of FIG. 1, in accordance with embodiments of the disclosure;

FIG. 3 is a simplified partial perspective view of a continuous fiber extruder module for an additive manufacturing tool, in accordance with embodiments of the disclosure;

FIG. 4A is a simplified partial perspective view of a nozzle assembly for an additive manufacturing tool, in accordance with embodiments of the disclosure;

FIG. 4B is a simplified partial cutaway cross-sectional view of the nozzle assembly of FIG. 4A;

FIG. 5 is a simplified partial perspective view of an end effector for an additive manufacturing tool, in accordance with additional embodiments of the disclosure;

FIG. 6 is a simplified partial perspective view of the additive manufacturing tool of FIG. 1 illustrating the additive manufacturing tool in a different configuration than that illustrated in FIG. 1;

FIG. 7A is a simplified partial perspective view of an end effector including a laser and focusing optics assembly, in accordance with embodiments of the disclosure;

FIG. 7B is a simplified partial perspective view of the laser and focusing optics assembly of FIG. 7A;

FIG. 8 is a simplified partial cutaway cross-sectional view of an extruder module for an additive manufacturing tool, in accordance with embodiments of the disclosure; and

FIG. 9 is a simplified flow diagram illustrating a method of forming an article, in accordance with embodiments of the disclosure.

### DETAILED DESCRIPTION

Illustrations presented herein are not meant to be actual views of any particular material, component, or system, but are merely idealized representations that are employed to describe embodiments of the disclosure. Additionally, elements common between figures may retain the same numerical designation for convenience and clarity.

The following description provides specific details, such as material types, compositions, material thicknesses, and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional techniques employed in the industry. In addition, the description provided below does not form a complete process flow for additively manufacturing a structure, for forming a carbon/carbon composite structure, a metal matrix composite structure, or a ceramic matrix composite structure. Only those process acts and structures necessary to understand the embodiments of the disclosure are described in detail below. Additional acts or materials to form an additively manufacturing structure, a carbon/carbon composite structure, a metal matrix composite structure, or a ceramic matrix composite structure may be performed by conventional techniques.

According to embodiments disclosed herein, a structure may be formed by additive manufacturing using a multi-axis additive manufacturing tool. The additive manufacturing tool may comprise a six-axis tool, as described in further detail below, and may be configured to additively manufacturing the structure in three dimensions. For example, the additive manufacturing tool may not be limited to forming the structure layer by layer by forming one plane of the structure in a 2D plane (e.g., the XY plane) and sequentially forming additional layers vertically over the structure in a vertically displaced XY plane from the previous layer. The additive manufacturing tool according to embodiments of the disclosure may be configured to form the structure in the vertical direction (a direction perpendicular to a build platform; the Z-direction) simultaneously with forming the structure in the 2D plane (the plane extending parallel to the build platform; the XY plane). In other words, the additive manufacturing tool may be configured to deposit a feed material to form the structure while moving a deposition nozzle along the Z-axis.

One or more feed materials may be used in the additive manufacturing tool. At least one of the feed materials comprises a continuous fiber material disposed within a matrix material. The matrix material comprises one or more thermoset materials. During fabrication of the structure, the feed material is fed through an end effector assembly including a continuous fiber feed nozzle assembly to a surface of a substrate or a structure being formed. As the feed material passes through the continuous fiber feed nozzle assembly, the feed material is heated, such as by exposure to thermal energy (e.g., in the form of a laser beam) to reduce the viscosity of the feed material, at least partially cure the thermoset resin of the feed material, and increase the temperature of the structure proximate the continuous fiber feed nozzle assembly. The heated feed material is placed on the surface of the structure being formed and is cooled upon contacting the surface of the structure.

Using the thermoset material in the feed material may improve the properties of the structure formed from the feed material. In contrast, conventional feed materials for additive manufacturing tools comprise thermoplastic materials. The thermoset material may exhibit a melt temperature higher than the melt temperature of thermoplastic materials used in conventional additive manufacturing techniques. Therefore, the resulting structure may be configured to exhibit a higher glass transition temperature (T_{g}) compared to structures formed from thermoplastic materials. Accordingly, the structure according to embodiments of the disclosure may be exposed to relatively higher temperatures during use and operation thereof compared to conventional structures formed from thermoplastic materials. In addition, the structure comprising the thermoset material may be exposed to one or more additional processes after additively manufacturing the structure. For example, the structure may be exposed to a cure process, a carbonization process, and one or more infiltration processes to form a final structure comprising, for example, a carbon/carbon composite structure, a metal matrix composite structure, or a ceramic matrix composite structure. The thermoset material may exhibit a higher char yield responsive to a carbonization process compared to a char yield of a thermoplastic material. The resulting structure may exhibit an improved density compared to conventionally formed structures.

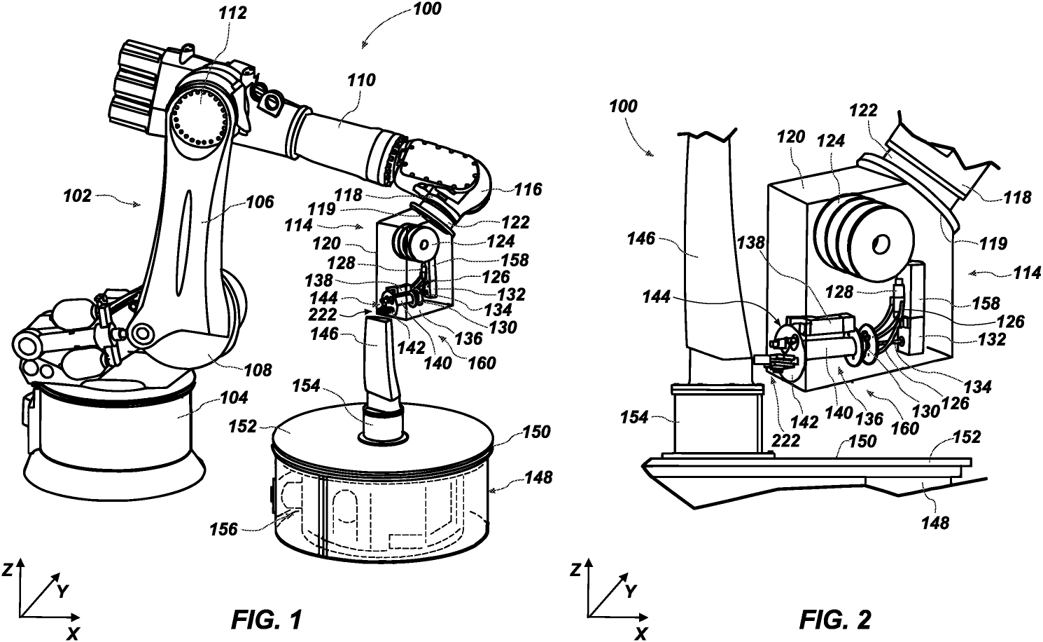

FIG. 1 is a simplified partial perspective view of an additive manufacturing tool 100, in accordance with embodiments of the disclosure. The additive manufacturing tool 100 comprises a robot 102 comprising a base portion 104, an extension arm 106 coupled to the base portion 104 by a pivot joint 108, and a working arm 110 coupled to the extension arm 106 by an additional pivot joint 112. The working arm 110 may be coupled to the extension arm 106 at an end of the extension arm 106 opposite the base portion 104.

The pivot joint 108 and the additional pivot joint 112 may comprise a hinge. The pivot joint 108 may be configured to effectuate movement of the extension arm 106 relative to the base portion 104. In other words, the pivot joint 108 facilitates independent movement of the extension arm 106 relative to the base portion 104. The additional pivot joint 112 may be configured to effectuate movement of the working arm 110 relative to the extension arm 106. In other words, the additional pivot joint 112 may be configured to facilitate independent movement of the working arm 110 relative to the extension arm 106.

An end effector 114 (also referred to as an “automated fiber placement tool head” (AFP head)) is coupled to the working arm 110 at an end of the working arm 110 opposite the additional pivot joint 112. The end effector 114 is operably coupled to the working arm 110 with a third pivot joint 116. The third pivot joint 116 comprises a coupling mechanism 118 that may include, for example, a flange. The coupling mechanism 118 is configured to couple the end effector 114 to third pivot joint 116. The third pivot joint 116 is configured to effectuate movement of the end effector 114 relative to the working arm 110. In other words, the third pivot joint 116 may be configured to facilitate independent movement of the end effector 114 relative to the working arm 110.

Cooperative operation and movement of the extension arm 106 and the working arm 110 facilitates desired movement of the end effector 114 in three dimensions. For example, the movement of the extension arm 106 and the working arm 110 may facilitate movement of the end effector 114 independently in each of the X-direction, the Y-direction, and the Z-direction.

The end effector 114 comprises a print-head assembly for placing one or more feed materials 126 (e.g., a molten fiber, a molten filament), described in further detail below, on a build surface, to form a structure 146. Although FIG. 1 illustrates a particular configuration of the end effector 114, the disclosure is not so limited and the additive manufacturing tool 100 may include end effectors other than that illustrated in FIG. 1.

FIG. 2 is a simplified partial perspective view of the additive manufacturing tool 100 more clearly illustrating components of the end effector 114. With combined reference to FIG. 1 and FIG. 2, the end effector 114 is coupled to the coupling mechanism 118 at an angled orientation on an angled wall 119. The end effector 114 includes an outer housing 120 and a rotatable connector 122 that is releasably and rotatably connected to the coupling mechanism 118. For convenience, the outer housing 120 is illustrated as being transparent in FIG. 1 and FIG. 2 to show the internal components thereof. The outer housing 120 may include one or more spools 124 therein, three of which are illustrated in FIG. 1 and FIG. 2. Each of the spools 124 independently includes a feed material 126 wound thereon. The spools 124 are configured to feed the feed materials 126 through a nozzle assembly 144 (also referred to as a “fused filament fabrication” nozzle) and/or a continuous fiber feed nozzle assembly 222 (also referred to as a “continuous fiber nozzle assembly”) during formation of the structure 146. In some embodiments, the continuous fiber feed nozzle assembly 222 is configured to deposit a feed material 126 comprising continuous fiber material disposed in a thermoset resin material (e.g., a pre-impregnated material, also referred to as a “prepreg” material) on a surface of the structure 146 being formed. The nozzle assembly 144 may be configured to deposit a feed material 126 comprising a different material composition than the feed material 126 passed through the continuous fiber feed nozzle assembly 222. In some embodiments, the nozzle assembly 144 is used to extrude a feed material 126 comprising chopped fibers dispersed in a matrix material (e.g., a thermoplastic matrix material, a thermoset matrix material). Although FIG. 1 and FIG. 2 have been described and illustrated as including both the nozzle assembly 144 and the continuous fiber nozzle assembly 222, the disclosure is not so limited. In other embodiments, the additive manufacturing tool 100 includes only the continuous fiber nozzle assembly 222.

Although FIG. 1 and FIG. 2 have been described and illustrated as including the spools 124 mounted within the outer housing 120, the disclosure is not so limited. In other embodiments, the spools 124 may be located external to the outer housing 120 and distal from the end effector 114. In some such embodiments, the feed material 126 is fed to (e.g., extruded to) the end effector 114 through a tube.

A motor 128 is configured to selectively and independently draw the feed material 126 from one of the spools 124 to the nozzle assembly 144 and a different feed material 126 from a different spool 124 to the continuous fiber nozzle assembly 222 by means of a feed assembly 130. In some embodiments, the motor 128 is coupled to the end effector 114 by means of a bracket 158. The feed assembly 130, the nozzle assembly 144, and the continuous fiber nozzle assembly 222 collectively comprise a feed module 160 configured to extrude the feed material 126 from the spools 124.

The feed assembly 130 is coupled to a right angle gear box 132 by a shaft 134. The right angle gear box 132 is coupled to an indexing motor 138 and is configured to drive (e.g., rotate) the shaft 134. The shaft 134 couples the right angle gear box 132 to the feed assembly 130.

Movement of the indexing motor 138 induces rotation of a rotary assembly 136. The rotary assembly 136 includes a barrel 140 through which the feed materials 126 are drawn towards the nozzle assembly 144 and the continuous fiber nozzle assembly 222. The nozzle assembly 144 and the continuous fiber nozzle assembly 222 extend through an end plate 142 mounted to an end of the barrel 140.

The structure 146 is formed on a build platform 148. The build platform 148 includes a rotary table 150 including an upper surface 152 on which the structure 146 being formed is shown. An optional riser 154 is provided on the upper surface 152 of the rotary table 150 (e.g., at the center of the rotary table 150). The structure 146 being formed may be placed on the riser 154. The riser 154 may be configured to provide structural support to the structure 146 during the additive manufacturing process. In other embodiments, the structure 146 is formed directly on the upper surface 152 of the rotary table 150.

In FIG. 1 and FIG. 2, the end effector 114 is illustrated in a horizontal orientation horizontally neighboring the structure 146 being formed. Placing the structure 146 on the riser 154 during additive manufacturing of the structure 146 may facilitate separation of the structure 146 from the upper surface 152 of the rotary table 150 which allows for separation of the end effector 114 from the rotary table 150 and manipulation of the orientation of the end effector 114 during additive manufacturing of the structure 146. For example, separation of the end effector 114 from the rotary table 150 facilitates an increased distance between the end effector 114 and the associated nozzle assembly 144 from the upper surface 152 of the rotary table 150 and provides space for maneuvering the nozzle assembly 144 and end effector 114 around the structure 146 during the additive manufacturing process.

In some embodiments, the riser 154 is formed of a thermally conductive material, such as copper. Forming the riser 154 from a thermally conductive material facilitates improved thermal transfer to the structure 146 and adhesion of the structure 146 to the riser 154. Although the riser 154 is illustrated as having a particular size and shape, the disclosure is not so limited, and the riser 154 may have a different size, shape, and geometry than illustrated in FIG. 1 and FIG. 2.

The rotary table 150 includes internal components 156, illustrated in broken lines in FIG. 1, that are configured to facilitate selective rotation of the rotary table 150 during use and operation of the additive manufacturing tool 100. In some embodiments, the rotary table 150 may be configured to rotate relative to the feed module 160 (e.g., the nozzle assembly 144 and the continuous fiber nozzle assembly 222) during formation of the structure 146. Rotation of the rotary table 150 facilitates rotation of the structure 146 relative to the nozzle assembly 144 and the continuous fiber nozzle assembly 222. Relative rotational movement of the structure 146 with respect to the feed module 160 facilitates formation of the structure 146 having desired shapes and geometries. Accordingly, rotation of the rotary table 150 comprises an additional degree of freedom of the additive manufacturing tool 100 during operation thereof (e.g., during formation of the structure 146).

In some embodiments, the internal components 156 further comprise a heater for heating the upper surface 152 of the rotary table 150 and the riser 154 (or the structure 146 where the structure is formed in contact with the upper surface 152).

During use and operation of the additive manufacturing tool 100, the feed material 126 is fed through the nozzle assembly 144 and/or the continuous fiber nozzle assembly 222. Each of the nozzle assembly 144 and the continuous fiber nozzle assembly 222 may be configured to heat the feed material 126 is heated. Heating the feed material 126 as it passes through the nozzle assembly 144 and/or the continuous fiber nozzle assembly 222 reduces a viscosity of the feed material 126 and increases the flowability of the feed material 126 through the respective one of the nozzle assembly 144 and the continuous fiber nozzle assembly 222. After passing through the nozzle assembly 144 or the continuous fiber nozzle assembly 222, the feed material 126 is initially brought into contact with the riser 154 and, thereafter, a build surface of the structure 146 being formed. The nozzle assembly 144 or the continuous fiber nozzle assembly 222, in combination with the rotary table 150, are moved to position the nozzle assembly 144 or the continuous fiber nozzle assembly 222 at a desired orientation with respect to the structure 146 being formed to place (e.g., deposit) the feed material 126 on the surface of the structure 146 and “build up” the structure 146.

As described in further detail herein, one or more of the nozzle assembly 144, the continuous fiber nozzle assembly 222, and the end effector 114 includes one or more heating elements (e.g., a heat block, a laser) for heating the feed material 126. As the heated feed material 126 is brought into contact with the surface of the structure 146, the feed material 126 cools, forming additional material (e.g., an additional layer) on the structure 146 being formed.

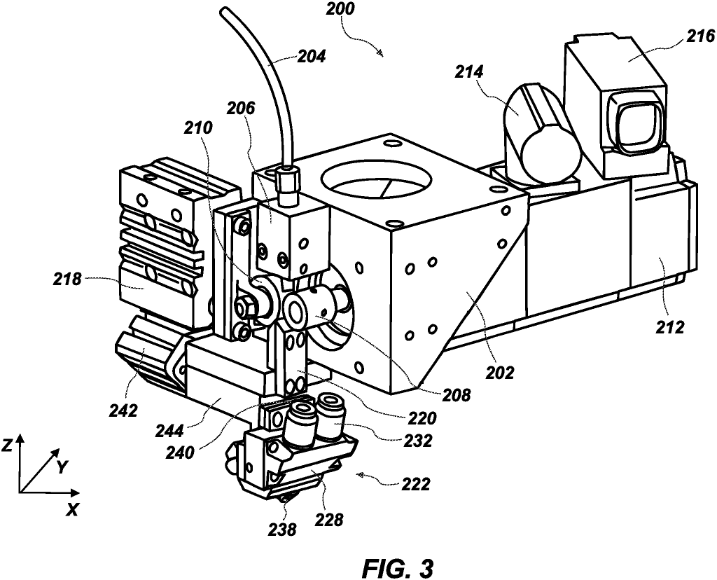

FIG. 3 is a simplified partial perspective view of a continuous fiber feed module 200 configured for feeding the feed material 126 (FIG. 1. FIG. 2) through the continuous fiber nozzle assembly 222. The continuous fiber feed module 200 may be provided as a portion of the end effector 114 described and illustrated in FIG. 1 and FIG. 2. For example, with reference to FIG. 3, the continuous fiber feed module 200 includes a mounting bracket 202 that is configured to be attached to (e.g., mounted to) at least a portion of the end effector 114 (FIG. 1, FIG. 2). In some embodiments, the mounting bracket 202 is attached to the feed assembly 130 of the end effector 114. In other embodiments, the mounting bracket 202 is configured to be attached to the end plate 142. In other embodiments, the continuous fiber feed module 200 includes a right angle gear box to rotate the feed motor by about 90° and facilitate packaging of the continuous fiber feed module 200 with the end effector 114. In additional embodiments, the mounting bracket 202 is configured to be attached to the bracket 158, the feed guide tube 206 configured to receive the feed material 1286 from the motor 128 or directly from one of the spools 124.

The continuous fiber feed module 200 includes a feed guide tube 204 configured to contain the feed material 126. In use and operation, the feed material 126 passes from the feed guide tube 204 through a feed guide mounting bracket 206, then between a feed roller 208 and a clamp roller 210. The feed guide mounting bracket 206 is configured to receive the feed material 126 from the feed guide tube 204. The feed roller 208 is operably coupled to a feed motor 212 that is electrically coupled to a power connector 214 and an encoder 216. The feed motor 212 provides the motive force for moving (e.g., translating) the feed material 126 through the continuous fiber feed module 200.

The clamp roller 210 is coupled to a clamp roller actuator 218 that presses the clamp roller 210 against the feed material 126, pinching the feed material 126 between the feed roller 208 and the clamp roller 210 with a sufficient amount of force to provide friction (e.g., traction) between the feed roller 208 and the clamp roller 210 to translate the feed material 126 without substantial slippage.

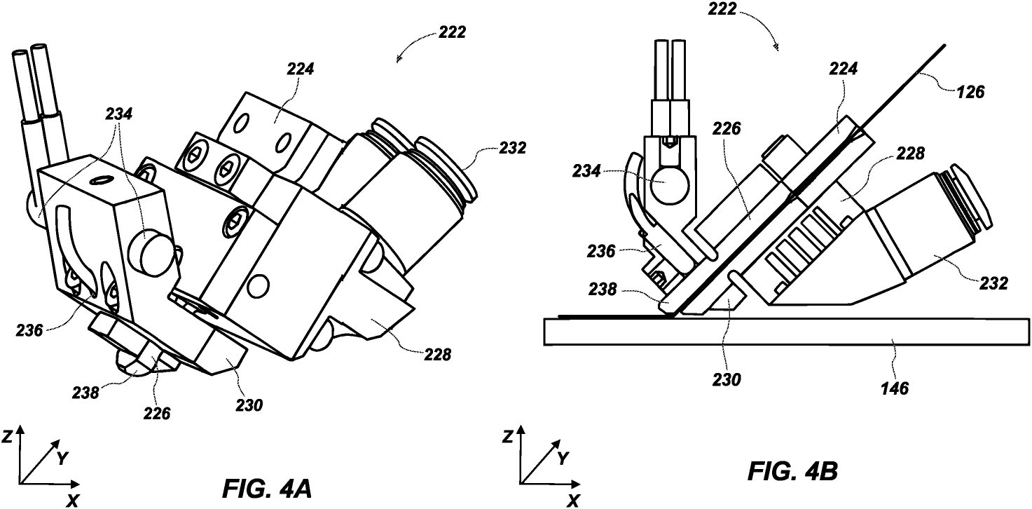

After passing between the feed roller 208 and the clamp roller 210, the feed material 126 passes through a feed guide 220 and into the continuous fiber nozzle assembly 222. FIG. 4A is a simplified partial perspective view of the continuous fiber nozzle assembly 222 and FIG. 4B is a simplified partial cross-sectional cutaway view of the continuous fiber nozzle assembly 222.

With collective reference to FIG. 4A and FIG. 4B, the continuous fiber nozzle assembly 222 includes a feed inlet 224 and a nozzle 226. A cooling block 228 is disposed around (e.g., clamped around) the feed inlet 224 and the nozzle 226. In addition, a heating block 230 is disposed around (e.g., clamped around) the feed inlet 224 and the nozzle 226. The cooling block 228 includes coolant hose connectors 232 for receiving coolant hoses carrying a coolant fluid. For example, the coolant hose connectors 232 may include a coolant hose connector 232 for receiving a chilled coolant fluid and another coolant hose connector 232 for receiving a heated coolant fluid. The heating block 230 includes a heating element 234 for providing heat to the heating block 230. A temperature indicator 236 is mounted to monitoring a temperature of the heating block 230. The temperature indicator 236 may include, for example, a thermocouple, a thermistor, or a resistance temperature detector (RTD).

The feed material 126 passes through the continuous fiber nozzle assembly 222 and to a nozzle tip 238. At the nozzle tip 238, the feed material 126 may be heated and/or cooled to melt, tackify, and/or soften the feed material 126 to facilitate bonding of the feed material 126 at the surface of the structure 146. Providing the temperature indictor 236 facilitates maintaining the temperature of the feed material 126 at a temperature less than a melting temperature of the feed material 126 until it is proximate a nozzle tip 238.

With reference back to FIG. 3, a cutter 240 may be located between the feed guide 220 and the continuous fiber nozzle assembly 222. The cutter 240 may be operated by a cutter actuator 242. The cutter 240 may be constrained by a cutter guide 244. Responsive to actuation of the cutter actuator 242, the cutter 240 is moved in a direction toward the feed material 126 with a predetermined force and in a direction substantially perpendicular to the feed material 126 direction to shear the feed material 126 against an underside of the feed guide 220 and cut the feed material 126. The cutter 240 may facilitate cutting of the feed material 126 to a desired length during formation of the structures 146.

The structure and orientation of the feed guide 220 and the continuous fiber nozzle assembly 222 facilitates feeding of the feed material 126 through the nozzle 226 (FIG. 4A, FIG. 4B) in a single direction. In some embodiments, the nozzle 226 is configured to be rotated to different orientations to facilitate extrusion of the feed material 126 in different directions. For example, and as described above with reference to FIG. 1 and FIG. 2, the continuous fiber nozzle assembly 222 is coupled to the rotary assembly 136 (FIG. 1, FIG. 2) (e.g., by means of the mounting bracket 202) such that the continuous fiber nozzle assembly 222 is configured to be rotated relative to the structure 146 being formed. By way of comparison, conventional 3D printing nozzles designs are restricted to print directions that are perpendicular to the axis of the nozzle.

Accordingly, rotation of the continuous fiber nozzle assembly 222 (e.g., with the rotary assembly 136 (FIG. 1, FIG. 2)) facilitates placement of the feed material 126 at desired locations (e.g., surfaces) of the structure 146 during formation of the structure 146. In some embodiments, the continuous fiber nozzle assembly 222 is rotatable with respect to the other components of the end effector 114. In some such embodiments, the placement of the feed material with respect to the structure 146 may be controlled without rotating the entire end effector 114. In other words, the placement of the feed material 126 on the structure 146 may be controlled by rotating the continuous fiber nozzle assembly 222 with the rotary assembly 136 as opposed to rotating the end effector 114, which is bulky and more difficult to rotate than the continuous fiber nozzle assembly 222. Similarly, the nozzle assembly 144 may be rotated with respect to the other components of the end effector 114, as described with reference to the continuous fiber module assembly 222.

In some embodiments, the end effector 114 (FIG. 1, FIG. 2), includes a cutting tool configured to remove material (e.g., by subtractive manufacturing) from the structure 146 during formation of the structure 146.

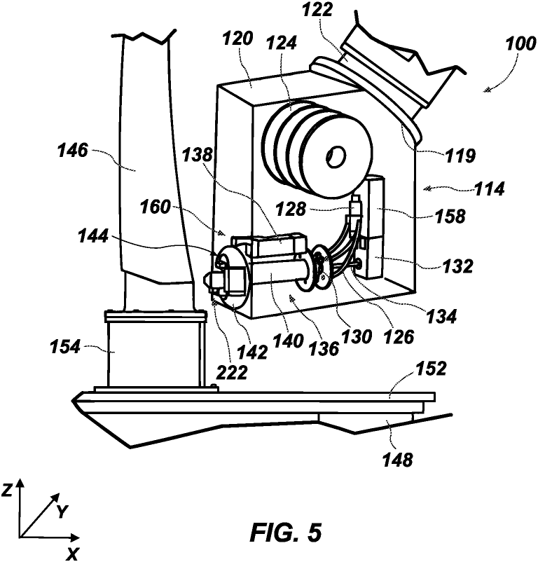

FIG. 5 is a simplified perspective view of the additive manufacturing tool 100 illustrating components of the end effector 114 with the nozzle assembly 144 and the continuous fiber nozzle assembly 222 rotated by about 90° with respect to the orientation of the nozzle assembly 144 and the continuous fiber nozzle assembly 222 illustrated in FIG. 1 and FIG. 2. As described above, the nozzle assembly 144 and the continuous fiber nozzle assembly 222 may be rotated by the rotary assembly 136. Rotation of the nozzle assembly 144 and the continuous fiber nozzle assembly 222 increases the ability of the additive manufacturing tool 100 to form structures 146 having a desired size, shape, and geometry.

In FIG. 1, FIG. 2, and FIG. 5 the end effector 114 is illustrated in a predominantly horizontal orientation such that the nozzle assembly 144 and the continuous fiber nozzle assembly 222 are directed substantially parallel to the upper surface 152 of the build platform 148, which allows the feed material 126 to be formed on a side of the build surface. In some embodiments, movement of the nozzle assembly 144 and the continuous fiber nozzle assembly 222 in the Z-direction (e.g., movement of the end effector 114 in the Z-direction, such as by movement of the extension arm 106 and the working arm 110) facilitates formation of (e.g., deposition of) the feed material 126 on the structure 146 in the Z-direction.

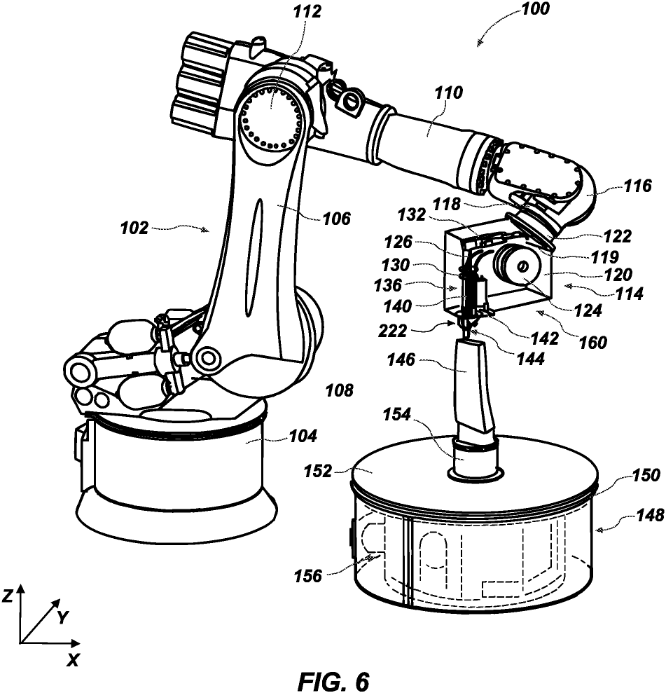

FIG. 6 is a simplified partial perspective view of the additive manufacturing tool 100 illustrating the end effector 114 in a different orientation than that illustrated in FIG. 1, FIG. 2, and FIG. 5. The end effector 114 may be moved to a different orientation with respect to the structure 146 and the rotary table 150 by, for example, rotating the rotatable connector 122. In FIG. 6, the end effector 114 is illustrated in a predominantly vertical orientation such that the feed materials 126 may be placed on the upper surface of the structure 146 (e.g., the surface of the structure 146 farthest from the upper surface 152 of the rotary table 150). It will be understood that the end effector 114 may be in any orientations intermediate between the orientations illustrated in FIG. 1, FIG. 2, and FIG. 5 and the orientation illustrated in FIG. 6 by rotation of the rotatable connector 122.

Rotation of the end effector 114 by the rotatable connector 122 and connection of the end effector 114 on the rotatable connector 122 with the angled wall 119 facilitates selective movement of the nozzle assembly 144 and the continuous fiber nozzle assembly 222 in desired paths. Movement of the nozzle assembly 144 and the continuous fiber nozzle assembly 222 in desired paths allows for formation of relatively complex structures 146 having more complex geometries and shapes than structures formed by conventional additive manufacturing tools. The rotation of the end effector 114 adds another degree of freedom of the additive manufacturing tool 100.

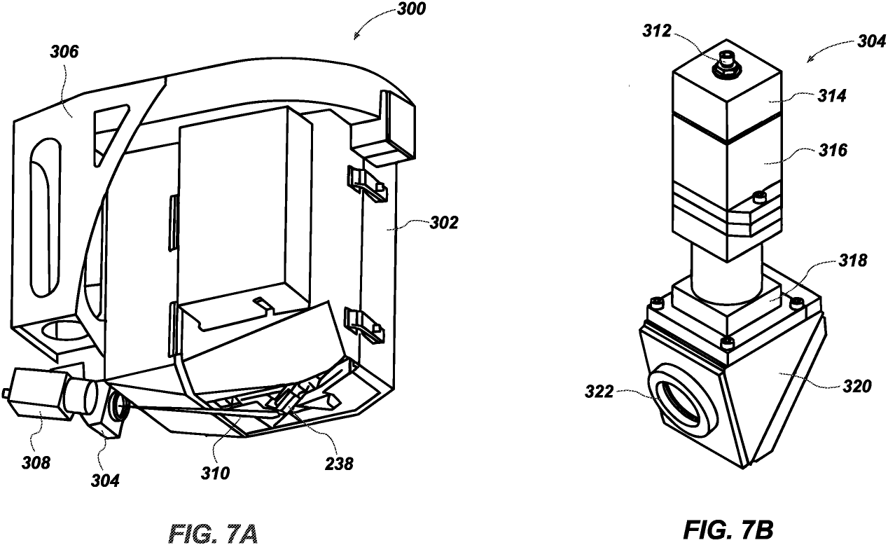

FIG. 7A is a simplified perspective view of an assembly 300 that may be used with the additive manufacturing tool 100. The assembly 300 includes an outer housing 302 to facilitate mounting of a laser focusing optics assembly 304 thereon. In some embodiments, the outer housing 302 is configured to be disposed around a perimeter of the continuous fiber feed module 200 (FIG. 3) while leaving at least the nozzle tip 238 extending through an opening in the outer housing 302. In some embodiments, a bracket 306 of the assembly 300 is coupled to (e.g., disposed around at least a portion of) the outer housing 302 configured to be attached to at least a portion of the continuous fiber feed module 200 (FIG. 3), such as to the mounting bracket 202 (FIG. 3). Accordingly, in some embodiments, the continuous fiber feed module 200 includes the assembly 300 disposed around the continuous fiber feed module 200.

The bracket 306 is configured to support the laser focusing optics assembly 304 and an infrared (IR) camera 308. The infrared (IR) camera 308 and the laser focusing optics assembly 304 are attached to the bracket 306. The laser focusing optics assembly 304 is configured to direct a laser beam 310 to the nozzle tip 238 that extends beyond the outer housing 302. As described in further detail below, the laser beam 310 is configured to heat the feed material 126 from the nozzle tip 238 and preheat surfaces of the structure 146 being formed to form a melt pool proximate where the heated feed material 126 is deposited.

The IR camera 308 may be configured to measure a temperature of the feed material 126 exiting the nozzle tip 238 and the surface of the structure 146 being formed. The IR camera 308 facilitates control of the temperature of the feed material 126 during extrusion thereof from the nozzle tip 238. For example, based on the temperature measured by the IR camera 308, the power of the laser focusing optics assembly 304 may be adjusted to increase or decrease the temperature of the feed material 126 and the surface of the structure 146 proximate the nozzle tip 238.

In some embodiments, heating the feed material 126 with the laser focusing optics assembly 304 facilitates an increased density of a fiber material (e.g., a continuous fiber material) within the feed material 126, improving the properties of the structure 146 formed with the additive manufacturing tool 100. In some embodiments, a power of the laser beam 310 is tailored to partially cure (e.g., partially thermally cure) the feed material 126 during formation of the structure 146. In other embodiments, the power of the laser beam 310 is configured to facilitate snap curing of the feed material 126 during formation of the structure 146 such that the feed material 126 is substantially instantaneously cured during formation of the structure 146.

Although FIG. 7A illustrates the laser focusing optics assembly 304 and the IR camera 308 mounted to the bracket 306 and the bracket 306 mounted to the outer housing 302, the disclosure is not so limited. In other embodiments, the laser focusing optics assembly 304 and the IR camera 308 are located inside the outer housing 302 of the assembly 300 and the laser beam 310 and the IR camera 308 are directed through an opening or a transparent window (e.g., glass) of the outer housing 302.

FIG. 7B is a simplified partial perspective view of the laser focusing optics assembly 304. The laser focusing optics assembly 304 includes a connector for connecting the laser focusing optics assembly 304 to a fiber optic assembly 312. The fiber optic assembly 312 may be connected to a collimated optics assembly 314 configured to collimate the laser beam 310 and to a beam shaping assembly 316 configured to shape the laser beam 310. A focusing lens 318 may be coupled to the beam shaping assembly 316 and a folding optics assembly 320 is configured to receive the laser beam 310 from the focusing lens 318. A housing cover 322 (e.g., a glass housing cover) covers the components of the laser focusing optics assembly 304.

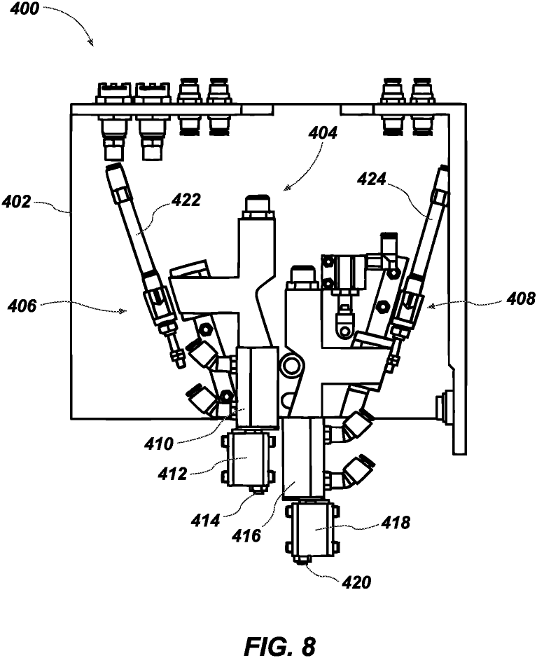

Although the extruder module 160 (FIG. 1, FIG. 2, FIG. 5, FIG. 6) and the continuous fiber feed module 200 (FIG. 3) have been described and illustrated as having a particular configuration, the disclosure is not so limited. FIG. 8 is a simplified partial cutaway view of an extruder module 400 that may replace the extruder modules 160, 200.

The extruder module 400 may be attached to, for example, the rotary assembly 136 of the end effector 114 such that the extruder module 400 is rotatable by the rotary assembly 136. The extruder module 400 includes an outer housing 402 enclosing a dual extruder assembly 404 including a first extruder module 406 and a second extruder module 408. In some embodiments, the first extruder module 406 includes a cold block 410 and a heating block 412 disposed around a nozzle 414. The first extruder module 406 and the nozzle 414 are configured to extrude a first type of feed material 126 for formation of the structure 146.

The second extruder module 408 includes a cold block 416 and a heating block 418 disposed around a nozzle 420. The second extruder module 408 and the nozzle 420 are configured to extrude a second type of feed material 126 having a different material composition than the first type of feed material 126 for formation of the structure 146.

Actuators 422, 424 are coupled to the first extruder module 406 and the second extruder module 408 for facilitating extraction of the respective nozzles 414, 420 out of the outer housing 402 for use of the feed materials 126 associated with the nozzles 414, 420.

In some embodiments, the additive manufacturing tool 100 may be positioned within an oven to facilitate control of an ambient temperature proximate the additive manufacturing tool 100.

In use and operation, the additive manufacturing tool 100 may be configured to move with multiple degrees of freedom during fabrication of the structure 146. In some embodiments, the additive manufacturing tool 100 comprises a so-called 6-axis tool. In some such embodiments, the additive manufacturing tool 100 is configured to move independently in each of six (6) axes including, for example, movement of the end effector 114 in the X-direction; movement of the end effector 114 in the Y-direction; movement of the end effector 114 in the Z-direction; rotation of the end effector 114 relative to the rotary table 150 around the X-axis; rotation of the end effector 114 relative to the rotary table 150 around the Y-axis; and rotation of the end effector 114 relative to the rotary table 150 around the Z-axis. In some embodiments, rotation of the end effector 114 relative to the rotary table 150 is effected by one or both of rotation of the rotary table 150 and rotation of the nozzle assembly 144 by means of the rotary assembly 136. In some embodiments, movement of the end effector 114 in each of the X-direction, the Y-direction, and the Z-direction is effected by one or more of movement of the rotary table 150 in the Z-direction, movement of the extension arm 106 in the X-direction, the Y-direction, and the Z-direction, and movement of the working arm 110 in the X-direction, the Y-direction, and the Z-direction.

The feed material 126 may include matrix material and one or more fiber materials dispersed throughout the matrix material. The matrix material may comprise a thermoset resin material (also referred to herein as a “thermosetting resin material” a “thermoset matrix material”, or a “thermoset matrix resin material”). In some embodiments, at least some of the spools 124 of the feed material 126 comprise the thermoset resin material and the other spools 124 of the feed material 126 comprise another material (e.g., a thermoplastic material).

In some embodiments, at least some of the feed material 126 comprises the matrix material and a continuous fiber material disposed therein. In some embodiments, the feed material 126 comprises a so-called “pre-impregnated” (also referred to as a “pre-preg”) continuous fiber material, meaning that the continuous fiber material is disposed within the matrix material. In some embodiments, the feed material 126 comprises a continuous fiber material within a thermoset resin material.

In some embodiments, the matrix material comprises a thermoset resin material. By way of non-limiting example, the thermoset resin material may include at least one of one or more resin materials including epoxies, polyesters resins, phenolic resins, cyanate ester resins (e.g., including a —O—C═N group attached to a phenyl ring, such as bisphenol A cyanate ester, bisphenol E cyanate ester, bisphenol F cyanate ester, novolac cyanate ester phenolic triazine), a bismaleimide (BMI) resin (e.g., 4-4′-bis(maleimido)diphenylmethane polymer, bis(maleimido)diphenylmethane copolymerized with 2-2′-diallyl bisphenol A (DBA), BMI triazine copolymer, bismaleimide-diamine copolymers, BMI epoxy copolymer, BMI dialkylphenyl copolymer, BMI bis(propylphenoxy) copolymer, BMI diamine copolymer), a polycyanurate (e.g., bisphenol A dicyanate, bisphenol E dicyanate, bisphenol M dicyanate, tetramethyl bisphenyl F dicyanate, dicyclopentadienyl bisphenolcyanate), a polyimide (PI) material, a polyetherimide (PEI), a polyamide (PA) resins, a polyamide imide (PAI) resin, a thermoset vinyl ester resin (e.g., bisphenol-A-epoxy vinyl esters), a phenolic resin (e.g., a novolac resin), a polyurethane resin, a polycarbonate resin, a phthalonitrile resin, and a phenol-formaldehyde material. Although the thermoset resin material has been described above as including particular thermoset resin materials, the disclosure is not so limited. In some embodiments, the thermoset resin material comprises one or more thermoset materials other than those described herein. In some embodiments, using a thermoset resin material in the feed material 126 facilitates formation of a structure 146 having a higher temperature capability compared to structures formed using thermoplastic materials. As described in further detail herein, the feed material 126 may be cured during and/or after formation of the structure 146.

In some embodiments, the thermoset resin material comprises a cyanate ester resin. In other embodiments, the thermoset resin material comprises a bismaleimide resin.

The thermoset resin material may be thermally stable at temperatures greater than about 175° C. (about 347° F.), greater 200° C. (about 392° F.), greater than about 250° C. (about 482° F.), greater than about 300° C. (about 572° F.), greater than about 350° C. (about 662° F.), greater than about 400° C. (about 752° F.), greater than about 500° C. (about 932° F.), greater than about 600° C. (about 1,112° F.), or greater than about 700° C. (about 1,292° F.). By way of comparison, resin materials formed from thermoplastic materials may not be stable at temperatures greater than about 200° C. (about 392° F.). For example, a glass transition temperature T_{g} of polyether ether ketone (PEEK) (a conventional thermoplastic material) is about 143° C. (about 289° F.) and a melting temperature is about 343° C. (about 649.4° F.). By way of comparison, a glass transition temperature T_{g} of thermoset cyanate esters may be within a range of from about 190° C. to about 350° C.; and a glass transition temperature T_{g} of thermoset bismaleimide resins, polyimide, or phthalonitrile resins may be greater than about 260° C., such as greater than about 300° C., or greater than about 350° C.

Thermal energy, such as that provided by the power of the laser beam 310, may be tailored to facilitate curing of the thermoset resin material during application of the feed material 126 on the structure 146. The laser beam 310 may heat the thermoset resin material of the feed material 126 while simultaneously at least partially curing the thermoset resin material. Stated another way, the laser beam 310 may at least partially cross-link the thermoset resin material during formation of the structure 146. In some embodiments, the laser beam 310 partially cures the thermoset resin material and does not substantially completely cure the thermoset resin material during formation of the structure 146. The thermal energy may also be provided to the materials through one or more of infrared radiation, induction heating, hot air/steam flow, and ultrasonic vibration.

The fiber material dispersed within the matrix material may include one or more continuous fiber materials. The continuous fiber material may be at least partially (e.g., substantially) surrounded (e.g., enveloped) by the matrix material. As used herein, the term “continuous” fiber material means and includes a fiber material that is substantially integral and exhibits an aspect ratio (e.g., a ratio of a first dimension, such as a length, to a second dimension, such as a diameter or a width) greater than about 10:1, such as greater than about 20:1, greater than about 50:1, greater than about 100:1, greater than about 500:1, or greater than about 1,000:1. In some embodiments, the feed material 126 including a continuous fiber material may comprise a continuous fiber material within the feed material 126 of an entire spool 124. In some embodiments, the continuous fiber material comprises a continuous fiber tow.

The continuous fiber material may be formed of and include any material(s) compatible with other components (e.g., the matrix material, such as the thermoset resin material) of the feed material 126. As used herein, the term “compatible” means and includes a material that does not react with, break down, or absorb another material in an unintended way, and that also does not impair the chemical and/or mechanical properties of the another material in an unintended way. By way of non-limiting example, the continuous fibers material may be formed of and include one or more of carbon fibers, ceramic fibers (e.g., oxide-based ceramic fibers, such as one or more of alumina fibers, alumina-silica fibers, and alumina-boria-silica fibers); non-oxide-based ceramic fibers, such as one or more of silicon carbide (SiC) fibers, silicon nitride (SiN) fibers, fibers including SiC on a carbon core, SiC fibers containing titanium, silicon oxycarbide fibers, silicon oxycarbonitride fibers; etc., polymeric fibers (e.g., thermoset plastic fibers, such as one or more of polyimide (PI) fibers, polyurethane (PU) fibers, phenol-formaldehyde fibers, urea-formaldehyde fibers, polyester fibers), glass fibers, boron fibers, polymer fibers loaded with fillers, and other fibers. A material composition of the continuous fiber material may be selected relative to a material composition of the matrix material. In some embodiments, the continuous fiber material comprises continuous carbon fiber.

In some embodiments, the feed material 126 may further include one or more chopped fiber materials. In some embodiments, the feed material 126 comprises one or more continuous fiber materials and one or more chopped fiber materials. The chopped fiber materials may include one or more of the materials described above with reference to the continuous fiber materials.

In some embodiments, at least one of the feed materials 126 from at least one of the spools 124 comprises a continuous fiber material disposed within the matrix material. At least another of the feed materials 126 of at least another of the spools 124 comprises chopped fiber materials disposed within the matrix material. In some embodiments, the feed material 126 including the chopped fiber materials includes the chopped fiber materials dispersed in a thermoplastic matrix material.

In some embodiments, the feed material 126 may include one or more additives therein to improve processing and provide desired properties to the resulting structure 146. The one or more additives may be dispersed within the thermoset resin material. By way of non-limiting example, the feed material 126 may include strengthening fillers (e.g., chopped fibers, carbon nanotubes, anisotropic fillers), functional fillers to provide electrical conductivity (e.g., carbon nanotubes, metal fibers, carbon black, salts, chopped metallized fibers, etc.), fillers to increase the thermal conductivity of the feed material (e.g., ceramic particles and similar materials), viscosity modifiers (e.g., plasticizers, toughening agents, or similar fillers), one or more metals (e.g., one or more refractory metals (e.g., niobium, molybdenum, tantalum, tungsten, rhenium), aluminum, vanadium, chromium, manganese, iron, cobalt, nickel, copper, zinc, yttrium, zirconium, ruthenium, rhodium, palladium, silver, cadmium, indium, tin, hafnium, osmium, iridium, platinum, gold, lead, bismuth), one or more semimetals (e.g., silicon, boron), one or more ceramic materials (e.g., one or more carbide materials (e.g., silicon carbide, tungsten carbide, aluminum carbide, titanium carbide, boron carbide), one or more nitride materials (e.g., silicon nitride, aluminum nitride, boron nitride, tantalum nitride, tungsten nitride, titanium nitride), one or more oxide materials (e.g., aluminum oxide, hafnium oxide, zirconium oxide, tungsten oxide, titanium oxide, magnesium oxide)), graphite, or carbon black.

The feed material 126 may include a first group of additives and at least a second group of additives. In other embodiments, one of the spools 124 comprises a feed material 126 including at least a first type of additive and at least one additional one of the spools 124 comprises a feed material 126 including at least a second, different type of additive.

In some embodiments, the one or more additives comprises a semimetal, such as silicon. In other embodiments, the one or more additives comprises an oxide material. In other embodiments, the one or more additives comprises one or more of tungsten, hafnium, and zirconium.

In use and operation, the structure 146 may be formed by extruding one or more feed materials 126 from the spools 124 and through the continuous fiber nozzle assembly 222 and, optionally, the nozzle assembly 114. In some embodiments, the feed materials 126 fed through the continuous fiber nozzle assembly 222 are exposed to the laser beam 310 substantially concurrently with extrusion of the feed materials 126 from continuous fiber nozzle assembly 222 to heat the feed material 126 and at least partially cure (e.g., thermally cure) the feed material 126. The heated feed material 126 is deposited on a surface of the build platform 148, a surface of the riser 154, or a layer or portion of the structure 146 previously formed. Exposure of the feed material 126 including the thermoset resin material may at least partially cure the thermoset material substantially simultaneously with placing the feed material 126 on the surface of the structure 146 being formed. In some embodiments, the power of the laser focusing optics assembly 304 is configured to snap cure the thermoset material during deposition thereof on the structure 146 to substantially completely cure the thermoset resin material.

In some embodiments, the power of the laser focusing optics assembly 304 is tailored based on an amount of cure desired for the feed material 126 during deposition thereof on the structure 146. By way of non-limiting example, if the feed material 126 is not sufficiently cured during formation of the structure 146, the thermoset material of the structure 146 may exhibit low viscosity transitions causing the fiber material (e.g., the continuous fiber material) within the feed material 126 to slip (also referred to as slump). In some embodiments, substantially completely curing the thermoset material during formation of the structure 146 may not be desired because it may increase the temperature of the structure 146 more than desired during the additive manufacturing process. In some embodiments, the laser focusing optics assembly 304 softens the feed material 126 to facilitate bonding of the feed material 126 to the riser 154. In some such embodiments, the feed material 126 may be partially cured (e.g., incompletely cured) during deposition on the surface of the riser 154 and will be subsequently completely cured, such as after forming the structure 146. A cure profile of the structure 146 after forming of the structure 146 with the additive manufacturing tool 100 may be tailored to prevent or substantially reduce slumping of the fiber materials of the structure 146. In other embodiments, the feed material 126 may be snap cured substantially concurrently with deposition of the feed material 126 on the structure 146 to facilitate substantially instantaneous curing of the feed material 126 during formation of the structure 146. In some such embodiments, the structure 146 may be formed in a shorter amount of time and may be formed with a lower energy requirement compared to what is required for consolidation of thermoplastic materials through a melting consolidation process. In addition, feed materials 126 comprising a thermoset resin material may be less expensive than thermoplastic feed materials.

In some embodiments, the continuous fiber nozzle assembly 222 and the nozzle assembly 122 move in one or more directions during formation of the structure 146. In some embodiments, at least one of the feed materials 126 comprises a thermoset resin material (e.g., one of a thermoset cyanate ester resin and a thermoset bismaleimide resin) and a continuous fiber material (e.g., a continuous carbon fiber material). The feed material 126 is substantially simultaneously formed on the structure 146 in each of the X-direction, the Y-direction, and the Z-direction. Accordingly, in some embodiments, the structure 146 may include a continuous fiber material spanning in 3 dimensions (e.g., in each of the X-direction, the Y-direction, and the Z-direction). As previously noted and by way of comparison, conventional additive manufacturing tools are unable to form continuous fiber materials in 3 dimensions. For example, conventional additive manufacturing tools form a structure layer by layer by moving the nozzle in the XY plane to form a layer in the XY plane. After forming a layer in the XY plane, the nozzle is stepped in the Z-direction relative to the previously-formed layer and another layer is formed in the XY plane. Accordingly, the resulting structure of conventional additive manufacturing processes does not include continuous fiber materials extending in the Z-direction. In addition, conventional additive manufacturing tools are not capable of depositing the feed material in the Z-direction. By way of contrast, the structure 146 may include one or more portions that are formed by moving the continuous fiber nozzle assembly 222 in the Z-direction while depositing the feed material 126 on the structure 146 to form the structure 146 having continuous fibers extending in the Z-direction. Thus, the structure 146 may be formed to exhibit improved properties (e.g., tensile strength, compressive strength) in all three dimensions and along each of the X-axis, the Y-axis, and the Z-axis.

In some embodiments, the structure 146 is formed to include continuous fiber materials in a 2-dimensional plane (e.g., the XY plane). In some embodiments, the structure 146 comprises a cylindrical structure. After forming the cylindrical structure, additional feed material 126 may be formed on the outside of the cylindrical structure, such as by spiral winding the additional feed material 126 around the circumference of the cylindrical structure. The spiral winding may extend in each of the X-direction, the Y-direction, and the Z-direction.

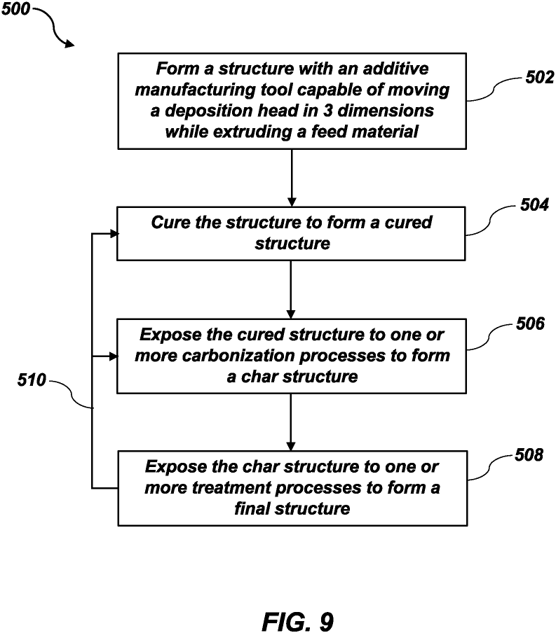

FIG. 9 is a simplified flow diagram illustrating a method 500 of forming a structure. The method 500 includes act 502 comprising forming a structure with an additive manufacturing tool capable of moving (e.g., configured to move) a deposition head in 3 dimensions and/or rotating the deposition head and/or the structure along 3 mutually independent and orthogonal axes (e.g., the X-axis, the Y-axis, and the Z-axis) while extruding a feed material; act 504 including curing the structure to form a cured structure; act 506 comprising exposing the cured structure to one or more carbonization processes to form a char structure; and act 508 including exposing the char structure to one or more treatment processes to form a final structure.

Act 502 comprises forming a structure with an additive manufacturing tool capable of moving a deposition head in 3 dimensions and/or rotating the deposition head and/or build platform along 3 mutually independent and orthogonal axes (e.g., the X-axis, the Y-axis, and the Z-axis) while extruding a feed material. The additive manufacturing tool may comprise the additive manufacturing tool 100 described above with reference to FIG. 1 through FIG. 8. In some embodiments, the structure is formed with the additive manufacturing tool 100 comprising one or more feed materials 126 including continuous fiber materials disposed in a thermoset resin material. In some such embodiments, the structure comprises continuous fiber materials extending in three dimensions. In some embodiments, the structure is formed without stopping the extrusion of the feed material through the nozzle assembly. Stated another way, the structure may be formed without any breaks in the continuous fiber material. In some embodiments, one or both of the build platform and the nozzle are moved in three dimensions and/or the nozzle is rotated along one or more of the X-axis, the Y-axis, and the Z-axis while the feed material is formed on (e.g., deposited on) the structure.

Act 504 includes curing the structure to form a cured structure. In some embodiments, the structure includes thermoset resin materials that may be partially cured during formation of the structure with the additive manufacturing tool 100 to form the cured structure. In some embodiments, the cured structure comprises a polymer matrix composite (PMC) material.

Curing the structure includes exposing the structure to curing conditions to thermally cure the structure and form the cured structure. By way of non-limiting example, the structure may be exposed to one or more of an elevated temperature (also referred to as a “cure temperature”), electromagnetic radiation (e.g., ultraviolet radiation, infrared radiation), or moisture to cure the structure. In some embodiments, curing the structure may form cross-links (e.g., chemical cross-linking) between the molecules of the thermoset resin material to polymerize the thermoset resin material (e.g., polymerize the matrix material). Cross-linking the thermoset resins may form covalent bonds between components of the matrix material of the thermoset resin. In some embodiments, the cross-linked thermoset resin material may include one or more triazine rings (such as where the thermoset resin material comprises a cyanate ester).

In some embodiments, curing the thermoset resin material comprises exposing the structure to a cure temperature within a range from about 150° C. to about 200° C., such as from about 160° C. to about 190° C., for a duration of time. The duration may be from about 1 hour to about 2 hours. In other embodiments, curing includes a so-called “snap curing” process wherein the structure is exposed to a higher temperature, such as about 220° C. for a short duration of time, such as for about 10 seconds.

In some embodiments, a glass transition temperature T_{g} of the substantially cured thermoset resin material of the structure may be greater than about 250° C., such as greater than about 300° C., or greater than about 350° C.

Act 506 includes exposing the cured structure to one or more carbonization processes to form a char structure. As used herein, a “char structure” means and includes a structure that has undergone at least a partial thermal decomposition wherein hydrogen, oxygen, and other non-carbon elements are removed from an organic structure (e.g., carbon chains and carbon rings) to leave a carbon skeleton structure. In some embodiments, incompletely charred materials may include hydrogen, oxygen, and other non-carbon elements, but may include fewer atoms of hydrogen, oxygen, and other non-carbon elements than present prior to charring of the structure. Exposing the cured structure to the one or more carbonization processes may increase a porosity of the char structure compared to the porosity of the cured structure.

In some embodiments, exposing the cured structure to one or more carbonization processes comprises exposing the cured structure to one or more pyrolysis processes. In some embodiments, the cured structure is exposed to an elevated temperature in an inert atmosphere (e.g., a reducing atmosphere) to form a char structure. The elevated temperature may be greater than about 400° C., greater than about 500° C., greater than about 600° C., greater than about 700° C., greater than about 800° C., or greater than about 900° C.

In some embodiments, the carbonization process comprises exposing the cured structure to the elevated temperature in an inert atmosphere (e.g., in the absence of oxygen). Exposing the cured structure to the elevated temperature in the absence of oxygen may form a char. In some such embodiments, hydrogen, oxygen, and other non-carbon elements of the structure may be combusted, leaving a carbon-rich solid residue.

Forming the structure at act 502 from the thermoset resin materials (e.g., cyanate esters, polyimides, phthalonitriles) may facilitate a greater char yield compared to conventional structures formed from thermoplastic resin materials (such as PEEK, PEK, PAEK). As used herein, the term “char yield” of a material means and includes the mass of material remaining after exposure of the material to an elevated temperature in an inert environment (e.g., in the absence of oxygen) for a duration, wherein the mass of the material remaining is expressed as a percentage relative to the original mass of the material prior to exposure to the elevated temperature. The elevated temperature may be greater than about 400° C., greater than about 500° C., greater than about 600° C., greater than about 700° C., greater than about 800° C., or greater than about 900° C. The duration may be greater than about thirty minutes, greater than about 1 hour, greater than about 2 hours, or greater than about 3 hours. Without being bound by any particular theory, it is believed that the char yield of the structure is greater than the char yield of structures formed from thermoplastic materials because carbonization of thermoset resin materials such as cyanate esters may form triazine rings and carbonization of thermoset resin materials such as polyimides and phthalonitriles include a greater number (e.g., concentration, quantity of, percent of) aromatic rings than conventional thermoplastic materials.

By way of non-limiting example, the structure may exhibit a char yield, when exposed to an elevated temperature greater than about 600° C. in the absence of oxygen for a duration (e.g., about one hour), of greater than about 80%, such as greater than about 85%, greater than about 86%, greater than about 88%, greater than about 90%, greater than about 92%, greater than about 94%, or greater than about 95%. In some embodiments, the char yield is greater than about 90%. In some embodiments, such as where the thermoset resin material comprises a polyimide or a phthalonitrile material, the char yield is about 95%. By way of comparison, the char yield of conventional structures formed from thermoplastic materials may be, at most, about 84%. The higher char yield of structures formed from thermoset materials according to embodiments disclosed herein may facilitate the formation of a carbon composite structure having a higher density and a higher melting temperature compared to conventional structures formed from thermoplastic materials.

The char structure may exhibit a sublimation temperature greater than about 3,000° C. (about 5,432° F.), such as greater than about 3,316° C. (about 6,000° F.). In some embodiments, the char structure exhibits a sublimation temperature above about 3,300° C.

In some embodiments, such as where the feed material from which the structure is formed during act 502 includes a metal, exposing the structure to one or more carbonization processes may form one or more metal carbides or semimetal carbides corresponding to the metals present in the structure. In other words, during the carbonization process, one or more metals present in the structure may react with carbon present in the structure to form the metal carbide or semimetal carbide. By way of non-limiting example, silicon present in the structure may react with carbon from the thermoset material to form silicon carbides. In some embodiments, one or more of tungsten, aluminum, titanium, and boron which may respectively form tungsten carbide, aluminum carbide, titanium carbide, and boron carbide, respectively, after exposure to the one or more carbonization processes.

With continued reference to FIG. 9, act 508 includes exposing the char structure to one or more treatment processes to form a final structure. The one or more treatment processes may include one or more of exposing the char structure to one or more polymer infiltration processes to form a carbon/carbon composite structure; and exposing the char structure to one or more metal infiltration processes including one or more of exposing the char structure to a chemical vapor infiltration (CVI) process to form a final structure including a fiber-reinforced composite structure including one or more metals (e.g., a metal matrix composite (MMC) material), one or more ceramic materials (e.g., a ceramic matrix composite (CMC) material), or both within the fiber-reinforced composite structure; and exposing the char structure to one of a liquid metal infiltration process or a metal evaporation process to form a final structure including a composite structure including carbon and one or more metals, one or more ceramics, or both within the composite structure.

In some embodiments, the char structure is exposed to a polymer infusion process to increase a carbon content of the char structure and form a carbon/carbon composite structure. By way of non-limiting example, the char structure may be placed in a chamber and exposed to a vacuum assisted resin infusion (VARI) process. The VARI process may include reducing a pressure of the chamber to a negative pressure (e.g., a vacuum), such as with a vacuum pump. The chamber is filled with one or more resin materials that are flowed in contact with (e.g., through, past) the char structure. In some embodiments, the polymer material is formed within pores and on surfaces of the char material to form a carbon/carbon composite structure.

The polymer material may include one or more carbon-containing polymers, such as, for example, one or more of the materials described above with reference to the thermoset resin, pitch (a viscoelastic polymer derived from petroleum, tar, or plant material; also referred to as tar, bitumen, or asphalt), a thermoplastic material, or combinations thereof. In some embodiments, the polymer material comprises substantially the same material composition as the thermoset resin material. In some embodiments, the polymer material comprises a cyanate ester. In other embodiments, the polymer material comprises a bismaleimide resin. In other embodiments, the polymer material comprises a different material composition than the thermoset region.

After exposing the char structure to the polymer infusion process, in some embodiments, the carbon/carbon composite structure is exposed to an additional carbonization process or a cure process to cure the polymer material, as indicated at arrow 510. In some embodiments, the carbon/carbon composite structure is exposed to an elevated temperature for a duration to cure the polymer material, as described above with reference to act 504. In other embodiments, the carbon/carbon composite structure is exposed to an additional carbonization process, which may be substantially the same as that described above with reference to act 506. In some embodiments, a desired number of cycles of polymer infusion processes as described above with reference to act 508, followed by additional curing or carbonization processes as described with reference to acts 504 and 506, respectively, may be performed until the carbon/carbon composite structure exhibits a desired density and composition.

In some embodiments, act 508 includes exposing the char structure to a chemical vapor infiltration (CVI) process to form a final structure including a carbon/carbon composite structure including one or more metals to form a metal matrix composite (MMC) material, one or more ceramics, or both within the carbon/carbon composite structure. By way of non-limiting example, the char structure may be disposed in a chamber. The chamber may be sequentially filled with one or more reactive gases to form (e.g., deposit) one or more metals or one or more metal carbides on surfaces (e.g., within pores) of the char structure.

In some embodiments, the chamber may be maintained at an elevated temperature while exposing the char structure to the CVI process. In some embodiments, the temperature of the chamber may be greater than about 800° C., greater than about 900° C., greater than about 1,000° C., or greater than about 1,100° C.

The one or more reactive gases may include one or more precursor gases formulated and configured to form, for example, a carbon/carbon composite structure, a carbon composite structure comprising one or more of silicon carbide (SiC), tantalum carbide (TaC), tungsten carbide (WC), hafnium carbide (HfC), zirconium carbide (ZrC), niobium carbide (NbC), titanium carbide (TiC), vanadium carbide (VC), and boron carbide (B₄C). By way of non-limiting example, the one or more reactive gases may include one or more of methyltrichlorosilane (CH₃SiCl₃—H₂) (to form silicon carbide), a tantalum halide (e.g., tantalum (V) chloride) (TaCl₅) (to form tantalum carbide), tungsten hexafluoride (WF₆) (to form tungsten carbide), tetrakis(dimethylamido)hafnium (Hf(NMe₂)₄) (to form hafnium carbide), tetrakis(dimethylamido)zirconium (Zr(NMe₂)₄) (to form zirconium carbide), a niobium halide (e.g., niobium (V) chloride) (NbCl₅) (to form niobium carbide), a titanium halide (e.g., titanium tetrachloride) (TiCl₄) (to form titanium carbide), VOCl₃ (to form vanadium carbide), and diborane (B₂H₆) or trimethylborane (C₃H₉B) (to form boron carbide).

In some embodiments, the reactive gas may include diborane and one or more of the reactive gases described above (e.g., to form a metal diboride). By way of non-limiting example, the reactive gas may include one diborane and one or more of tantalum (V) chloride, tungsten hexafluoride, tetrakis(dimethylamido)hafnium, tetrakis(dimethylamido)zirconium, niobium (V) chloride, or titanium tetrachloride to respectively form one or more of tantalum diboride (TaB₂), Tungsten diboride (WB₂), hafnium diboride (HfB₂), zirconium diboride (ZrB₂), niobium diboride (NbB₂), or titanium diboride (TiB₂).

In some embodiments, the reactive gas may further include nitrogen to form a metal nitride (e.g., one or more of tantalum nitride (TaN), hafnium nitriude (HfN), zirconium nitride (ZrN), silicon nitride (Si₃N₄), niobium nitride (NbN), titanium nitride (TiN), vanadium nitride (VN), and boron nitride (BN)).

With continued reference to FIG. 9, in some embodiments, act 508 includes exposing the char structure to one of a liquid metal infiltration process or a metal vapor to form a final structure including a composite structure including carbon and one or more metals or semimetals, one or more ceramics, or both within the composite structure.

In some embodiments, the char structure is exposed to a liquid metal infiltration process. In some such embodiments, the char structure is soaked in a molten liquid metal. The liquid metal may include one or more refractory metals (e.g., niobium, molybdenum, tantalum, tungsten, rhenium), aluminum, silicon, vanadium, chromium, manganese, iron, cobalt, nickel, copper, zinc, yttrium, zirconium, ruthenium, rhodium, palladium, silver, cadmium, indium, tin, hafnium, osmium, iridium, platinum, gold, lead, and bismuth. In some embodiments, after infiltrating the char structure with one or more metals, the carbon metal composite structure may be exposed to an annealing process to react at least some of the metal with carbon from the char material and form one or more metal carbides.

In other embodiments, the char structure is exposed to a metal evaporation process to form the final structure. By way of non-limiting example, the char structure may be suspended over a melt pool of one or more metals. Metal vapors may evaporate from the melt pool and infiltrate the char structure, forming metal deposits within pores of the char structure.

In some embodiments, after exposing the char structure to the one or more treatment processes, acts 504, 506, and 508 may be repeated a desired number of times (as indicated at arrow 510) until the final structure exhibits a desired composition (e.g., carbon content, metal content), a desired density, or a combination thereof. By way of non-limiting example, in some embodiments, act 508 includes exposing the char structure to a polymer infiltration process followed by curing and carbonizing the resulting structure. Thereafter, the structure may be exposed to additional polymer infiltration processes, and one or more additional treatment processes. For example, after exposing the structure to the additional polymer infiltration processes, the structure may be exposed to one or more of a CVI process, a liquid metal infiltration process, and a metal vapor. In some embodiments, the structure may be sequentially exposed to a polymer infiltration process, a curing and carbonization process, one or more of a CVI process, a liquid metal infiltration process, and a metal vapor. After exposing the structure the one or more of the CIP process, the liquid metal infiltration process, and the metal vapor, the cycle of exposing the structure to a polymer infiltration process, a curing and carbonization process, one or more of a CVI process, a liquid metal infiltration process, and a metal vapor may be repeated a desired number of times to form a final structure exhibiting desired properties.

Forming the structure from the thermoset resin material and continuous fiber materials with the additive manufacturing tool 100 facilitates forming structures having desired structural and chemical properties. For example, using continuous fiber materials with the additive manufacturing tool facilitates forming structures including continuous fiber materials extending in three dimensions. In addition, forming the structure with the thermoset resin material facilitates forming the structure to exhibit a relatively higher char yield compared to structures formed from thermoplastic materials, increasing the density of a resulting PMC material, carbon/carbon composite structure, or MMC structure. Further, forming the structure with a thermoset resin matrix material may form the structure 146 having a higher glass transition temperature compared to structures formed from thermoplastic materials. In addition, in some embodiments, thermoset matrix resin materials may be deposited at a faster rate and may be less expensive than thermoplastic materials.

While the disclosure is susceptible to various modifications and alternative forms, specific embodiments have been shown by way of example in the drawings and have been described in detail herein. However, the disclosure is not intended to be limited to the particular forms disclosed. Rather, the disclosure is to cover all modifications, equivalents, and alternatives falling within the scope of the disclosure as defined by the following appended claims and their legal equivalents.

What is claimed is:

1. A method of forming a structure comprising a continuous fiber material, the method comprising:
continuously feeding, through a continuous fiber nozzle assembly of an additive manufacturing tool, a feed material comprising a continuous fiber material and a thermoset resin material;
heating or cooling the feed material to maintain a temperature of the feed material to a temperature sufficient to tackify the feed material and at least partially cure the feed material and initiate adhesion of the feed material on a build platform or a previously formed portion of a structure; and
moving the continuous fiber nozzle assembly in three dimensions while depositing the feed material on the build platform or the previously formed portion of the structure to form the structure comprising the continuous fiber material extending in three dimensions.

2. The method of claim 1, wherein continuously feeding, through a continuous fiber nozzle assembly of an additive manufacturing tool, a feed material comprising a continuous fiber material and a thermoset resin material comprises extruding a feed material comprising the continuous fiber material disposed within a thermoset resin material selected from the group consisting of a cyanate ester, an epoxy resin, a phenolic resin, a bismaleimide resin, a polyimide resin, and a phthalonitrile resin.

3. The method of claim 1, wherein continuously feeding, through a continuous fiber nozzle assembly of an additive manufacturing tool, a feed material comprising a continuous fiber material and a thermoset resin material comprises extruding a feed material comprising the continuous fiber material disposed within a thermoset resin material having a glass transition temperature greater than about 175° C. (about 347° F.).

4. The method of claim 1, wherein continuously feeding, through a continuous fiber nozzle assembly of an additive manufacturing tool, a feed material comprising a continuous fiber material comprises extruding a feed material comprising a continuous carbon fiber material disposed within the thermoset resin material.

5. The method of claim 1, wherein moving the continuous fiber nozzle assembly in three dimensions to form a structure comprising the continuous fiber material extending in three dimensions comprises:
forming a three dimensional structure; and
moving the nozzle in a Z-direction perpendicular to a build platform of the additive manufacturing tool while depositing the feed material on the three dimensional structure.

6. The method of claim 1, wherein continuously feeding, through a continuous fiber nozzle assembly of an additive manufacturing tool, a feed material comprising a continuous fiber material and a thermoset resin material comprises feeding, through the continuous fiber nozzle assembly, a feed material comprising a metal material dispersed throughout the thermoset resin material.

7. The method of claim 1, further comprising exposing the structure to one or more thermal curing processes to fully cure the thermoset resin material.

8. The method of claim 1, further comprising exposing the structure to a carbonization process to form a char structure.

9. The method of claim 8, wherein exposing the structure to a carbonization process comprises increasing a porosity of the structure.

10. The method of claim 8, further comprising exposing the char structure to at least one of a polymer infiltration process or a metal infiltration process.

11. The method of claim 10, wherein exposing the char structure to at least one of a polymer infiltration process or a metal infiltration process comprises exposing the char structure to a metal infiltration process selected from the group consisting of a chemical vapor infiltration process, a liquid metal infiltration process, and a metal evaporation process.

12. The method of claim 10, wherein exposing the char structure to at least one of a polymer infiltration process or a metal infiltration process comprises forming a structure comprising at least one metal carbide dispersed within a carbon network.

13. The method of claim 8, wherein moving the continuous fiber nozzle assembly in three dimensions to form a structure comprising the continuous fiber material comprises forming the structure to exhibit a char yield greater than about 80%.

14. A method of forming a composite structure, the method comprising:
forming a structure using a six-axis additive manufacturing tool, forming the structure comprising:
feeding a feed material comprising a pre-impregnated continuous fiber material dispersed within a thermoset resin material through a continuous fiber nozzle assembly of the additive manufacturing tool to a surface of a structure; and
while feeding the feed material through the continuous fiber nozzle assembly, exposing the feed material to thermal radiation to at least partially cure the feed material;
curing the structure to form a cured structure; and
carbonizing the cured structure to form a char structure.

15. The method of claim 14, wherein curing the structure to form a cured structure comprises curing the structure to form a polymer matrix composite structure having a glass transition temperature (T_{g}) greater than about175° C. (about 347° F.).

16. The method of claim 14, wherein curing the structure to form a cured structure comprises, while exposing the feed material to the thermal radiation, substantially completely curing the structure.

17. The method of claim 14, wherein feeding a feed material comprising a pre-impregnated continuous fiber material dispersed within a thermoset resin material through a continuous fiber nozzle assembly comprises feeding a feed material comprising a thermoset resin material selected from the group consisting of a cyanate ester, an epoxy resin, a phenolic resin, a bismaleimide resin, a polyimide resin, and a phthalonitrile resin.

18. The method of claim 14, wherein forming a cured structure comprises forming the cured structure to exhibit a char yield greater than 80%.

19. The method of claim 14, wherein carbonizing the cured structure to form a char structure comprises forming the char structure having a lower porosity than the cured structure.

20. The method of claim 14, further comprising exposing the char structure to at least one of a polymer infiltration process or a metal infiltration process to form a composite structure.

21. The method of claim 20, wherein exposing the char structure to at least one of a polymer infiltration process or a metal infiltration process comprises exposing the char structure to a polymer comprising the same material composition as the thermoset resin material.

22. The method of claim 21, further comprising curing the polymer.

23. The method of claim 20, wherein exposing the char structure to at least one of a polymer infiltration process or a metal infiltration process to form a composite structure comprises exposing the char structure to a metal infiltration process to form a composite structure comprising a metal carbide.

24. The method of claim 23, wherein forming a composite structure comprising a metal carbide comprises forming a composite structure comprising tungsten carbide.

25. The method of claim 23, wherein forming a composite structure comprising a metal carbide comprises forming a composite structure comprising silicon carbide.

26. The method of claim 23, wherein exposing the char structure to a metal infiltration process comprises exposing the char structure to a chemical vapor infiltration process.

27. The method of claim 23, wherein exposing the char structure to a metal infiltration process comprises exposing the char structure to a liquid metal infiltration process.

28. The method of claim 23, wherein exposing the char structure to a metal infiltration process comprises exposing the char structure to a metal evaporation process.

29. The method of claim 14, wherein feeding a feed material comprising a pre-impregnated continuous fiber material dispersed within a thermoset resin material through a continuous fiber nozzle assembly comprises feeding a feed material comprising the pre-impregnated continuous fiber material and a metal or a semimetal dispersed within the thermoset resin material through the continuous fiber nozzle assembly.

30. The method of claim 29, wherein feeding a feed material comprising the pre-impregnated continuous fiber material and a metal or a semimetal dispersed within the thermoset resin material through the continuous fiber nozzle assembly comprises feeding a feed material comprising silicon through the continuous fiber nozzle assembly.

31. The method of claim 29, wherein carbonizing the cured structure comprises forming a char structure comprising a ceramic matrix composite structure comprising a metal carbide or a semimetal carbide.

32. The method of claim 23, wherein exposing the cured structure to at least one of a polymer infiltration process or a metal infiltration process to form a composite structure comprises exposing the cured structure to a polymer material to form a composite structure having a melt temperature greater than about 2,500° C.

33. The method of claim 14, wherein curing the structure to form a cured structure and carbonizing the cured structure to form a char structure comprises:
curing the structure to form a cured structure;
exposing the cured structure to the carbonization process to form the char structure;
exposing the char structure to a polymer infiltration process to form a composite structure; and curing the composite structure.

34. A tool for additively manufacturing a structure, the tool comprising:
a build platform configured to hold a structure being formed;
an end effector including a continuous fiber nozzle assembly, the end effector configured to move in three dimensions with respect to the build platform and configured to rotate along three independent axis; and
a feed material comprising a continuous fiber material dispersed within a thermoset resin material.
